(19) United States
(12) Patent Application Publication
(10) Pub. No.: US 2015/0135991 A1
(43) Pub. Date: May 21, 2015

(54) METHOD OF DISSOLVING CELLULOSE

(71) Applicant: Hubei Tiansi Technology Company Limited, Xiaogan (CN)

(72) Inventors: Lian TANG, Xiaogan (CN); Jinping ZHOU, Xiaogan (CN); Yunbo WANG, Xiaogan (CN); Daoxi LI, Xiaogan (CN); Yaming LI, Xiaogan (CN); Zhiqiang ZHENG, Xiaogan (CN)

(21) Appl. No.: 14/540,696

(22) Filed: Nov. 13, 2014

Related U.S. Application Data
(63) Continuation of application No. PCT/CN2013/083373, filed on Sep. 12, 2013.

(30) Foreign Application Priority Data
Oct. 10, 2012 (CN) 201210380753.0

(51) Int. Cl. C08L 1/00

(52) U.S. Cl. CPC C08L 1/00
USPC 106/204.01

(57) ABSTRACT

A method of dissolving cellulose, comprising: firstly heating and activating the cellulose by using a heating apparatus, and then dissolving by using a solvent. The temperature of the heating and the activating is 130° C.-270° C., the time period of the heating is 0.1-100 hours, and the solvent is an aqueous solution including 6 wt %-12 wt % sodium hydroxide and 0.1 wt %-6 wt % zinc oxide. The method of dissolving comprises: heating and activating the cellulose with a degree of polymerization of DP=300-700, dispersing the cellulose into the solvent, and freezing under a temperature of −10˜-30° C. for 0.1-50 hours; then unfreezing under a condition of no more than 32° C., and standing or stirring by machine during the process of unfreezing so as to dissolve and obtain a cellulose solution with a concentration of 3 wt %-12 wt %. The obtained cellulose solution has a good solubility and stability that maintains a relatively good stability after being stood under a temperature of −8 to 32° C. for a few days. The cellulose solution can be used in the preparation of fibers, films or sponges, and is suitable for industrial production.

### FIELD

The disclosure herein relates to a method of dissolving cellulose.

### BACKGROUND

Cellulose is a renewable resource that widely exists in the nature. Due to its unique reactional properties and molecular characteristics, the cellulose can be expected to become one of the main chemical resources in the future. Currently, cellulose is closely related to textiles, light industry, chemical industry, defense, oil, medicine, biotechnology, environmental protection and energy, etc., and is widely used for producing cellulosic materials such as paper, fiber membranes, polymers and coatings, etc. However, the molecule of the natural cellulose has a relatively high crystallinity and a large number of hydrogen bonds between and within the molecules, making it difficult to dissolve, melt and process. For a long time, in the cellulose fiber regeneration field of the textile industry, viscose fibers have been playing a major role. A viscose process can produce ideal regenerated cellulose fibers, but the production process is complicated and difficult to control, and the required working space and utility consumption can be huge. A large number of toxic gases and waste water may be produced, causing serious pollution. This process is therefore being faced out. Currently, new no-toxic and harmless solvents and methods of dissolving cellulose have become an important development direction in the cellulose industry.

Cellulose solvents can be divided into non-derivatized solvents and derivatized solvents. A cellulose solvent is a derivatized solvent (CS₂/NaOH/H₂O, N₂O₄/dimethylformamide, etc.), if a derivative reaction occurs during the dissolving process of the cellulose. A cellulose solvent is a non-derivatized solvent (amine oxide system, LiOH/dimethylacetamide, ionic liquid, NaOH/urea, etc.), if no derivative is formed during the dissolving process. Since dissolving cellulose by a non-derivatized solvent is a physical process, the dissolving process does not impact the chemical structure of the cellulose easily, and the process for producing cellulose products is relatively simple.

In the development history of the cellulose products, a lot of researches have been focused on non-derivatized solvents. In 1939, U.S. Pat. No. 2,179,181 reported that tertiary amine oxides such as trimethyl amine oxide, triethyl amine oxide and dimethyl cyclohexyl amine oxide, etc. can dissolve cellulose. Later, British Patent No. 1144048 further reported that NMMO (4-methylmorpholine-N-oxide, N-methylmorpholine aqueous solution and methylmorpholine oxide, or chemical C₅H11NO₂) can be more suitable as a cellulose solvent. Dissolving cellulose by NMMO simplifies the process and reduces the amount of chemical raw materials used and energy consumption. The production process involves only physical changes, and the solvent NMMO used is non-toxic and environment-friendly. The obtained fiber product is called Lyocell (“Tencel” in China). However, the related issues may include the relatively high price of the solvent, stringent dissolving conditions, and complex recycling system. U.S. Pat. No. 4,302,252 provided that LiCL/DMAc (dimethylacetamide) system can form a solvate with cellulose, facilitating cellulose dissolving and has a good solubility and solubility. However, the system has a narrow dissolving time and is expensive. Also, DMAc is strongly irritating and has some toxicity. Celanese Company provided in GB patent t263810 that cellulose can be dissolved in a phosphoric acid system. The system is a complex solution of phosphoric acid and polyphosphoric acid. In the cellulose dissolving process, a temperature should be strictly controlled. In addition, to improve the solubility of the system, a mass fraction of P₂O₅ must also be increased. The dissolving time can also be relatively long, limiting the industrial adoption. In 1934, Graenacher found that melted N-ethyl pyridine chloride can dissolve cellulose. However, melted N-ethyl pyridine has a relatively melting point and was not used industrially. In 2002, Swatloski et al. found that cellulose can be dissolved directly in a room temperature ionic liquid without being activated. In the same year, it is reported the ionic liquid 1-butyl -3-methylimidazolium chloride can be used as a cellulose solvent. In 2003, Qiang Ren et al. synthesized a new room temperature ionic liquid 1-allyl-3-methylimidazolium chloride that also has a capability of dissolving cellulose. In 2005, Huimou Luo et al. synthesized chloride 1-(2-hydroxyethyl)-3-methylimidazolium ionic liquid, and found that the solubility of microcrystalline cellulose in the ionic liquid reaches 5%-7% when activated by a temperature of 70° C. However, this liquid begins to decompose when the temperature exceeds 80° C., thereby having no practical value. Patent No. JP1777283 disclosed dissolving cellulose in 2.5 mol/L NaOH aqueous solution. However, the cellulose can only be wood pulp cellulose that is treated by steam explosion, and the degree of polymerization of the wood pulp cellulose is less than 250. The wood pulp cellulose dissolves in the NaOH aqueous solution at a temperature of about 4° C. However, the fiber and membrane made by this method has a very low strength, and therefore is not suitable for industrial production. Literature <<Zhejiang Chemical Industries>> 1006-4184 (2007) 12-0001-03 disclosed using sulfite wood pulp board as the raw material and sodium hydroxide solution as the solvent to study cellulose dissolving in alkali. The viscosity of the mixture with a concentration of about 6 wt % is studied at a temperature of 2° C. However, the dissolving behavior under a lower temperature has not been studied, and the solubility and the stability of the solution have not been discussed in detail either, resulting in few practical values. In patents No. CN00114486.3, CN00114485.5, CNO3128386.1, CN200310111566.3, CN200410013389.X and WO 2006/128346A1 owned by Wuhan University disclosed using aqueous solutions of sodium hydroxide and urea, and aqueous solutions of sodium hydroxide and thiourea to directly dissolve natural cellulose under a low temperature condition. The solution can remain stable in a temperature range of 0-5° C. for a long term. Using such a solvent system can help obtain fibers and membranes in a laboratory. However, the properties of the cellulose solution in the system can be greatly affected by the temperature, therefore, the system has not been used industrialized.

Cellulose non-derivatized solvent would not produce chemical changes to cellulose during the production process. The process is simple and has been developed extensively. However, before using a general non-derivatized solvent to dissolve cellulose, the cellulose needs to be activated. The simplicity of the activation process, the environmental friendliness of the solvent, the stability of the obtained cellulose solution and the economy of the raw material can all limit the industrialization process.

### SUMMARY

The purpose of the disclosure herein is to provide a method of dissolving cellulose. The method includes: activating cellulose by heating the cellulose in a heating apparatus, and then dissolving the cellulose in a solvent. The solvent dissolves the cellulose by a freezing-unfreezing process to obtain a cellulose solution with a relatively high concentration and stability. The obtained cellulose solution can be used in making other cellulose products, such as fibers, membranes and sponges, etc.

To achieve the above purpose, in one embodiment, the technical solution discloses a method of dissolving cellulose, wherein the cellulose is activated by heating the cellulose in a heating apparatus, and then the cellulose is dissolved in a solvent.

Wherein, when activating the cellulose by heat, a heating temperature is 130-270° C., and a heating time is 0.1-100 hours.

The solvent is an aqueous solution including 6 w % t-12 wt % of sodium hydroxide and 0.1 wt %-6 wt % of zinc oxide.

Preferably, the solvent used for dissolving the cellulose is an aqueous solution including 7.0 wt %˜9.0 wt % of sodium hydroxide and 0.5 wt %˜2.0 wt % of zinc oxide.

In one embodiment, a method of dissolving cellulose according to the present disclosure, the dissolving of cellulose by a solvent includes the following steps:

1) Activating the cellulose by heating, where the cellulose has a polymerization degree of DP=300˜700, dispersing the activated cellulose by heat in the solvent, and freezing at a freezing temperature of −10˜-30° C. for a freeing time of 0.1˜50 hours;

2) Unfreezing the frozen material obtained in step 1) under a temperature of no more than 32° C., where the unfreezing is performed in standing still or with stirring, so as to dissolve and obtain a cellulose solution with a concentration of 3 wt %-12 wt %.

The method of dissolving cellulose, preferably,

In step 1), the freezing temperature is −12˜-18° C., the freezing time period is 0.1˜50 hours and the range of the degree of polymerization (DP) of the cellulose is 350˜550.

In step 2), the unfreezing temperature is 10˜22° C., and the concentration of the cellulose solution obtained by dissolving is 5.0 wt %˜8.5 wt %.

The cellulose solution obtained according to the present disclosure has a relatively good solubility and a relatively high stability, and can remain stable for several days at a temperature of −8˜32° C. The cellulose solution can be used for production of fibers, membranes or sponges, and is especially suitable for industrial production.

As compared to the traditional methods, the embodiments in the current disclosure have at least the following advantages:

1) Good solubility of the cellulose solution, the cellulose solution generally does not have colloidal particles with a diameter larger than 5 microns. Good stability, the cellulose solution does not change significantly after standing at the room temperature for 24˜120 hours. The concentration of the solution is relatively high, and the concentration of the solution according to the embodiments in the present disclosure can reach 3 wt %˜12 wt %, which is close to the cellulose concentration in the current viscose production method, and is suitable for industrial production.

2) The activating and dissolving processes are simple and easy to operate. During the dissolving process, only the freezing process requires low temperature environment, other processes can be carried out at room temperature. These help overcome the disadvantages of complexity and stringent conditions of the traditional methods.

3) The activating apparatus is simple and easy to implement. The solvent is easy to prepare. The components of the solvent can only include NaOH, zinc oxide and water. The components are cheap and very economic. Because the components of the solvent are simple, the solvent is easy to recycle in the cellulose production process, the recycling cost is also low and the recycled materials can be repeatedly used, which are advantageous for industrial scale production.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 illustrates a microscopic morphology of the cellulose solution made according to embodiment 1.

FIG. 2 illustrates a microscopic morphology of the cellulose solution made according to embodiment 2.

FIG. 3 illustrates a microscopic morphology of the cellulose solution made according to embodiment 3.

FIG. 4 illustrates a microscopic morphology of the cellulose solution made according to embodiment 4.

FIG. 5 illustrates a microscopic morphology of the cellulose solution made according to embodiment 5.

FIG. 6 illustrates a microscopic morphology of the cellulose solution made according to embodiment 6.

FIG. 7 illustrates a graph of the stability of the cellulose solutions according to embodiments 1 to 6 over time.

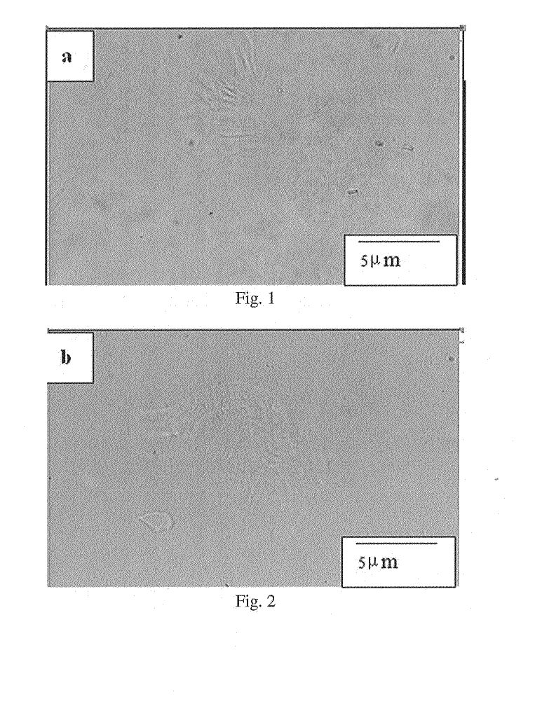

Note: FIGS. 1 to 6 are 100× magnified photos by a fiber projector CYG-055DI.

### DETAILED DESCRIPTION

To better understand the present disclosure, the following embodiments further explain the present disclosure in detail. It should be appreciated that the present disclosure is not limited by the following embodiments.

### Embodiment 1

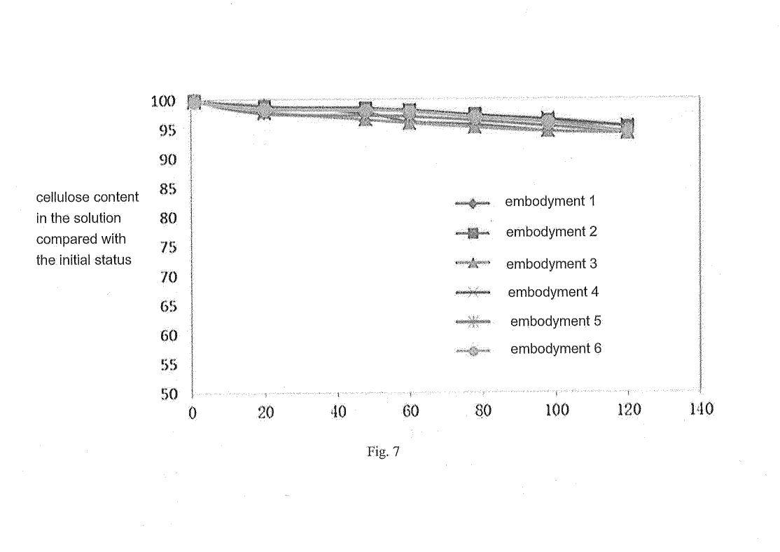

Weigh a certain mass of cotton pulp cellulose, where a degree of polymerization of the cotton pulp cellulose is 350, place into an oven and heat for 3 hours at a temperature of 138° C., take out and set aside. Using water as a solvent, prepare an aqueous cellulose solvent including sodium hydroxide at a mass concentration of 12% and zinc oxide at a mass concentration of 5%. Weigh the heated and activated cellulose and add the cellulose into the prepared cellulose solvent, so that a mass concentration of the cellulose is 8.5%, stir well to submerge all the cellulose below the liquid surface. Then put the mixture in a cold storage with a temperature of −15° C., freeze for 5 hours, take out and stand at room temperature for unfreezing, where the room temperature is 22° C. When the temperature of the mixture is raised to 22° C., stir by a glass rod to obtain a transparent cellulose solution. Take out a small amount of the cellulose solution, place onto a fiber projector CYG-055DI, observe and photograph by magnifying 100 times. A microscopic photo of the cellulose solution is shown in FIG. 1. The cellulose is dissolved completely and a diameter of the colloidal particle is less than 5 microns. Store the solution under the room temperature of 22° C. for 100 hours. At different time points, liquid from an upper level of the solution is taken and dried to weigh a solid content of the cellulose. A comparison to the solid content of the cellulose solution at the initial time point of 0 hour is shown in FIG. 7. After 100 hours, the settled content is 5.5 wt % and a weight ratio of the non-settled content is 94.5 wt %. The solubility and stability of the cellulose solution is good.

### Embodiment 2

Weigh a certain mass of cotton pulp cellulose, where a degree of polymerization of the cotton pulp is 550, place into an oven and heat for 0.3 hour at a temperature of 230° C., take out and set aside. Using water as a solvent, prepare an aqueous cellulose solvent including sodium hydroxide at a mass concentration of 7% and zinc oxide with a mass concentration of 1.0%. Weigh the heated and activated cellulose and add the cellulose into the prepared cellulose solvent, so that a mass concentration of the cellulose is 4.5%, stir well to submerge all the cellulose below the liquid surface. Then put the mixture in a cold storage with a temperature of −13° C., freeze for 12 hours, take out and stand at room temperature for unfreezing, wherein the room temperature is 23° C. When the temperature of the mixture is raised to 23° C., stir by a glass rod to obtain a transparent cellulose solution. Take out a small amount of the cellulose solution, place to a fiber projector CYG-055DI, observe and photograph by magnifying 100 times. A microscopic photo of the cellulose solution is shown in FIG. 2. The cellulose is dissolved completely and a diameter of the colloidal particle is less than 5 microns. Store the solution under the room temperature of 23° C. for 120 hours. At different time points, liquid from an upper level of the solution is taken and dried to weigh a solid content of the cellulose. A comparison to the solid content of the cellulose solution at the initial time point of 0 hour is shown in FIG. 7. After 120 hours, the settled content is 4.8 wt % and a weight ratio of the non-settled content is 95.2 wt %.

### Embodiment 3

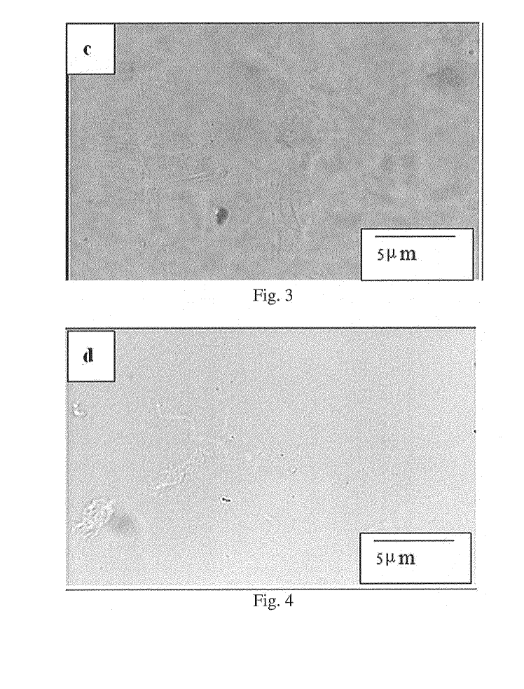

Weigh a certain mass of cotton pulp cellulose, where a degree of polymerization of the cotton pulp cellulose is 380, place into an oven and heat for 0.8 hour at a temperature of 190° C., take out and set aside. Using water as a solvent, prepare an aqueous cellulose solvent including sodium hydroxide at a mass concentration of 6% and zinc oxide at a mass concentration of 0.5%. Weigh the heated and activated cellulose and add the cellulose into the prepared cellulose solvent, so that a mass concentration of the cellulose is 5%, stir well to submerge all the cellulose below the liquid surface. Then put the mixture in a cold storage with a temperature of −16° C., freeze for 1 hour, take out and stir at a speed of 150 r/min under room temperature for unfreezing, where the room temperature is 22° C. When the temperature of the mixture is raised to 22° C., stir by a glass rod to obtain a transparent cellulose solution. Take out a small amount of the cellulose solution, place onto a fiber projector CYG-055DI, observe and photograph by magnifying 100 times. A microscopic photo of the cellulose solution is shown in FIG. 3. The cellulose is dissolved completely and a diameter of the colloidal particle is less than 5 microns. Store the solution under the room temperature of 22° C. for 120 hours. At different time points, liquid from an upper level of the solution is taken and dried to weigh a solid content of the cellulose. A comparison to the solid content of the cellulose solution at the initial time point of 0 hour is shown in FIG. 7. After 120 hours, the settled content is 5.9 wt % and a weight ratio of the non-settled content is 94.1 wt %.

### Embodiment 4

Weigh a certain mass of cotton pulp cellulose, where a degree of polymerization of the cotton pulp is 450, place into an oven and heat for 1 hour under a temperature of 175° C., take out and set aside. Using water as a solvent, prepare an aqueous cellulose solvent including sodium hydroxide with a mass concentration of 10% and zinc oxide with a mass concentration of 1.5%. Weigh the heated and activated cellulose and add the cellulose into the prepared cellulose solvent, so that a mass concentration of the cellulose is 7.0%, stir well to submerge all the cellulose below the liquid surface. Then put the mixture in a cold storage with a temperature of −25° C., freeze for 10 hours, take out and stand at room temperature for unfreezing, wherein the room temperature is 24° C. When the temperature of the mixture is raised to 24° C., stir by a glass rod to obtain a transparent cellulose solution. Take out a small amount of the cellulose solution, place to a fiber projector CYG-055DI, observe and photograph by magnifying 100 times. A microscopic photo of the cellulose solution is shown in FIG. 4. The cellulose is dissolved completely and a diameter of the colloidal particle is less than 5 microns. Store the solution under the room temperature of 24° C. for 120 hours. At different time points, liquid from an upper level of the solution is taken and dried to weigh a solid content of the cellulose. A comparison to the solid content of the cellulose solution at the initial time point of 0 hour is shown in FIG. 7. After 120 hours, the settled content is 4.7 wt % and a weight ratio of the non-settled content is 95.3 wt %.

### Embodiment 5

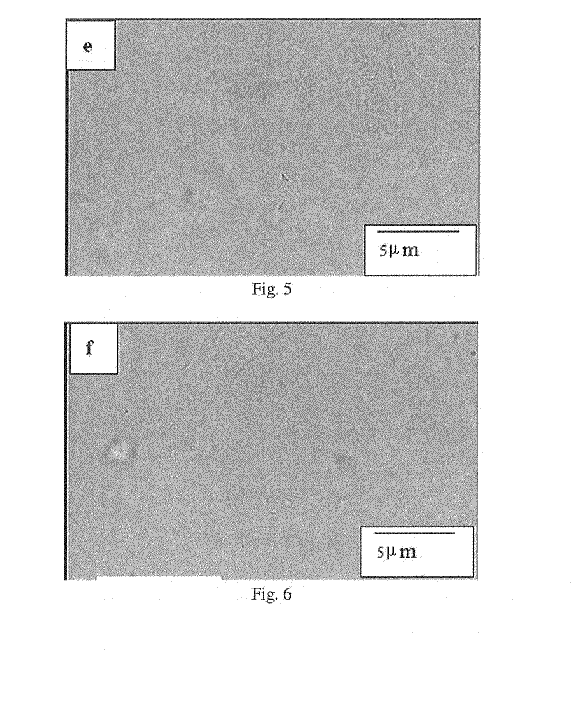

Weigh a certain mass of cotton pulp cellulose, where a degree of polymerization of the cotton pulp cellulose is 420, place into an oven and heat for 1.5 hours at a temperature of 210° C., take out and set aside. Using water as a solvent, prepare an aqueous cellulose solvent including sodium hydroxide at a mass concentration of 11% and zinc oxide with a mass concentration of 2.5%. Weigh the heated and activated cellulose and add the cellulose into the prepared cellulose solvent, so that a mass concentration of the cellulose is 6.5%, stir well to submerge all the cellulose below the liquid surface. Then put the mixture in a cold storage with a temperature of −20° C., freeze for 3 hours, take out and stand under room temperature for unfreezing, where the room temperature is 22° C. When the temperature of the mixture is raised to 22° C., stir by a glass rod to obtain a transparent cellulose solution. Take out a small amount of the cellulose solution, place onto a fiber projector CYG-055DI, observe and photograph by magnifying 100 times. A microscopic photo of the cellulose solution is shown in FIG. 5. The cellulose is dissolved completely and a diameter of the colloidal particle is less than 5 microns. Store the solution under the room temperature of 22° C. for 120 hours. At different time points, liquid from an upper level of the solution is taken and dried to weigh a solid content of the cellulose. A comparison to the solid content of the cellulose solution at the initial time point of 0 hour is shown in FIG. 7. After 120 hours, the settled content is 5.7 wt % and a weight ratio of the non-settled content is 94.3 wt %.

### Embodiment 6

Weigh a certain mass of cotton pulp cellulose, where a degree of polymerization of the cotton pulp is 500, place into an oven and heat for 1 hour under a temperature of 200° C., take out and set aside. Using water as a solvent, prepare an aqueous cellulose solvent including sodium hydroxide with a mass concentration of 8% and zinc oxide with a mass concentration of 0.7%.

Weigh the heated and activated cellulose and add the cellulose into the prepared cellulose solvent, so that a mass concentration of the cellulose is 7.5%, stir well to submerge all the cellulose below the liquid surface. Then put the mixture in a cold storage with a temperature of −28° C., freeze for 10 hours, take out and stand at room temperature for unfreezing, wherein the room temperature may be 21 ° C. When the temperature of the mixture is raised to 21° C., stir by a glass rod to obtain a transparent cellulose solution. Take out a small amount of the cellulose solution, place to a fiber projector CYG-055DI, observe and photograph by magnifying 100 times. A microscopic photo of the cellulose solution is shown in FIG. 6. The cellulose is dissolved completely and a diameter of the colloidal particle is less than 5 microns. Store the solution under the room temperature of 21° C. for 120 hours. At different time points, liquid from an upper level of the solution is taken and dried to weigh a solid content of the cellulose. A comparison to the solid content of the cellulose solution at the initial time point of 0 hour is shown in FIG. 7. After 100 hours, the settled content is 5.6 wt % and a weight ratio of the non-settled content is 94.4 wt %.

With regard to the foregoing description, it is to be understood that changes may be made in detail, without departing from the scope of the present invention. It is intended that the specification and depicted embodiments are to be considered exemplary only, with a true scope and spirit of the invention being indicated by the broad meaning of the claims.

1. A method of dissolving cellulose, comprising:
heating and activating the cellulose in a heating apparatus; and
dissolving with a solvent.

2. The method of dissolving cellulose of claim 1, wherein a heating temperature of the heating and activating the cellulose is 130-270° C., and a heating time is 0.1-100 hours.

3. The method of dissolving cellulose of claim 1, wherein the solvent is an aqueous solution including 6 wt %-12 wt % of sodium hydroxide and 0.1 wt %-6 wt % of zinc oxide.

4. The method of dissolving cellulose of claim 1, wherein the solvent is an aqueous solution including 7.0 wt %-9.0 wt % of sodium hydroxide and 0.5 wt %-2.0 wt % of zinc oxide.

5. The method of dissolving cellulose of any of claim 1 wherein the dissolving the cellulose comprising:
1) dispersing the heated and activated cellulose in the solvent, and freezing under a freezing temperature of −10˜-30° C. for a freezing time of 0.1˜50 hours, wherein a degree of polymerization of the heated and activated cellulose is DP=300˜700; and
2) unfreezeing the cellulose frozen by step 1) at a temperature of no more than 32° C., and standing or stirring by a machine so as to obtain a cellulose solution with a concentration of 3 wt %-12 wt %.

6. The method of dissolving cellulose of claim 5, wherein in step 1), the freezing temperature is −12˜-18° C. and the freezing time is 0.1˜50 hours.

7. The method of dissolving cellulose of claim 5, wherein in step 1), the degree of polymerization (DP) of the cellulose is 350˜550.

8. The method of dissolving cellulose of claim 5, wherein in step 2), the unfreezing temperature is 10˜22° C.

9. The method of dissolving cellulose of claim 5, wherein in step 2), the concentration of the cellulose solution obtained by dissolving is 5.0 wt %-8.5 wt %.
